(19) United States
(12) Patent Application Publication
(10) Pub. No.: US 2011/0279427 A1
(43) Pub. Date: Nov. 17, 2011

(54) LIQUID CRYSTAL DISPLAY DEVICE AND ELECTRONIC APPLIANCE

(75) Inventors: Atsushi UMEZAKI, Isehara (JP); Hiroyuki MIYAKE, Atsugi (JP)

(73) Assignee: SEMICONDUCTOR ENERGY LABORATORY CO., LTD., Kanagawa-ken (JP)

(21) Appl. No.: 13/094,864

(22) Filed: Apr. 27, 2011

(30) Foreign Application Priority Data
May 14, 2010 (JP) 2010-112269

(51) Int. Cl. G09G 3/36; G06F 3/038

(52) U.S. Cl. 345/209; 345/96

(57) ABSTRACT

An object of one embodiment of the present invention is to provide a liquid crystal display device using the common inversion driving that allows the amplitude voltage of a scan signal on a scan line to be low. The device including a first transistor having a gate, a first terminal, and a second terminal electrically connected to a scan line, a signal line, and a first electrode of a liquid crystal element, respectively; and a second transistor having a gate, a first terminal, and a second terminal electrically connected to the scan line, a common potential line, and a second electrode of the element, respectively. An image signal is supplied from the signal line to the first electrode to subject the element to inversion driving. A common potential is supplied from the common potential line to the second electrode in synchronization with supply of the image signal.

### BACKGROUND OF THE INVENTION

1. Field of the Invention

The present invention relates to a liquid crystal display device. Further, the present invention relates to a driving method of the liquid crystal display device. Further, the present invention relates to an electronic appliance including the liquid crystal display device.

2. Description of the Related Art

Liquid crystal display devices ranging from large display devices such as television receivers to small display devices such as mobile phones have been spreading. From now on, products with higher added values will be needed and are being developed. In recent years, a liquid crystal material exhibiting a blue phase (hereinafter referred to as blue phase liquid crystal) have attracted attention as a material that achieves higher definition and higher-value added. Blue phase liquid crystal responds to electric field much faster than a conventional liquid crystal material, and is expected to be used in liquid crystal display devices that need to be driven with a high frame frequency in order to display 3D images (three-dimensional images), or the like.

Patent Document 1 discloses IPS (in-plane switching) as a method for driving blue phase liquid crystal. Patent Document 1 particularly discloses the structure of electrodes between which a liquid crystal material is sandwiched, which structure is used to reduce the voltage for driving a liquid crystal element.

### REFERENCE

### Patent Document

[Patent Document 1] Japanese Published Patent Application No. 2007-271839

### SUMMARY OF THE INVENTION

IPS (in-plane switching) used as a method for driving blue phase liquid crystal disclosed in Patent Document 1 needs a high drive voltage. The cause of the high drive voltage will be described with reference to drawings.

FIG. 15A shows the circuit configuration of a pixel included in a liquid crystal display device. A pixel 1500 includes a transistor 1501, a liquid crystal element 1502, and a storage capacitor 1503. An image signal (also called a video signal) is input to a signal line 1504 (also called a data line, a source line, or a data signal line), and a gate signal (also called a scan signal or a selection signal) is input to a scan line 1505 (also called a gate line or a gate signal line). Further, a common potential is applied to a common potential line 1506 (also called a common line), and a fixed potential is applied to a capacity line 1507. Note that, for explanation, an electrode of the liquid crystal element 1502 that is connected to the transistor 1501 is a first electrode (also called a pixel electrode), and an electrode of the liquid crystal element 1502 that is connected to the common potential line 1506 is a second electrode (also called a counter electrode).

FIG. 15B is an example of a timing diagram used to describe the operation of the pixel 1500 shown in FIG. 15A that is subjected to inversion driving. The timing diagram of FIG. 15B shows the potentials of a scan line (GL), a signal line (SL), a common potential line (CL), a first electrode (PE), and a second electrode (CE), which potentials appear in one frame period in a inversion driving period 1511 and one frame period in a non inversion driving period 1512, during the inversion driving is performed.

In FIG. 15B, the potential of a scan signal on the scan line (GL) is Vgh in a period during which the pixel is selected, that is, a period during which the transistor 1501 is set in the conduction state (turned on); and Vgl (Vgh>Vgl) in the other period, that is, a period during which the transistor 1501 is set in the non-conduction state (turned off). The potential of the signal line (SL) fluctuates according to a displayed image. Here, the potential used to perform the non inversion driving is Vdh, and the potential used to perform the inversion driving is Vdl (Vdh>Vdl). Note that FIG. 15B shows the case where the potential of the first electrode (PE) varies according to the gray level of an image signal on the signal line (SL) and shows, for explanation, the scene where the potential of the first electrode (PE) is inverted between Vdh and Vdl according to a scan signal on the scan line (GL). In FIG. 15B, the potential of the common potential line (CL), that is, the potential of the second electrode (CE) is Vc.

Examples of the inversion driving include: the gate line inversion driving in which an image signal having a potential higher than the potential of the second electrode and an image signal having a potential lower than the potential of the second electrode are input to the pixels in turn on a row basis; the source line inversion driving in which an image signal having a potential higher than the potential of the second electrode and an image signal having a potential lower than the potential of the second electrode are input to the pixels in turn on a column basis; and the dot inversion driving in which an image signal having a potential higher than the potential of the second electrode and an image signal having a potential lower than the potential of the second electrode are input to the pixels in turn on a row basis and on a column basis.

In a driving method using the inversion driving that has been described with reference to FIG. 15B, the amplitude voltage of an image signal is high, leading to high power consumption. The common inversion driving in which the potential of the second electrode (CE) is inverted every certain period e.g., every frame is known as a technique to reduce power consumption by reducing the amplitude voltage of an image signal.

FIG. 15C is an example of a timing diagram used to describe the operation of the pixel 1500 that is subjected to the common inversion driving. FIG. 15C is different from FIG. 15B in showing the case where the potential of the second electrode (CE) obtained in the inversion driving period 1511 is in opposite phase to the potential of the second electrode (CE) obtained in the non inversion driving period 1512. In the driving method in FIG. 15C, the amplitude voltage of an image signal is a value lower than the value of the potential of the second electrode (CE) (Vdl) during a frame in which the potential of the second electrode (CE) is at the high level (Vch); and the amplitude voltage of an image signal is a value higher than the value of the potential of the second electrode (CE) (Vdh) during a frame in which the potential of the second electrode (CE) is at the low level (Vcl). Thus, the amplitude voltage of an image signal can be reduced to half compared to the driving method that has been described with reference to FIG. 15B. Consequently, the amplitude voltage of the image signal can be made low, thereby reducing power consumption.

As shown in FIG. 15C, in the common inversion driving, the potential of the first electrode (PE) is changed by capacitive coupling when the potential of the second electrode (CE) is inverted. Consequently, the potential of the first electrode (PE) exceeds or falls below the potential of an image signal. The voltage of a scan signal on the scan line (GL) needs to be higher so that such a potential of the first electrode (PE) may remain unchanged. Suppose that, for example, the potential of the first electrode (PE) is approximately the maximum potential of an image signal Vdh. Then, if the potential of the second electrode (CE) is inverted from the low level potential (Vcl) to the high level potential (Vch), the potential of the first electrode (PE) becomes higher than the maximum potential of an image signal Vdh (i.e. Vdh+ΔV). In contrast, suppose that, for example, the potential of the first electrode (PE) is approximately the minimum potential of an image signal Vdl. Then, if the potential of the second electrode (CE) is inverted from the high level potential (Vch) to the low level potential (Vcl), the potential of the first electrode (PE) becomes lower than the minimum potential of an image signal Vdl (i.e. Vdl−ΔV). For this reason, the potential of a scan signal on the scan line (GL) at the low level (Vgl) needs to be set lower than a potential lower than the potential of the first electrode (PE) that is lower than the minimum potential of an image signal Vdl (i.e. Vdl−ΔV) in order to turn off the transistor 1501. As a result, it is difficult to reduce the amplitude voltage of a scan signal on the scan line (GL) to a sufficient extent even with the common inversion driving.

The fact that the amplitude voltage of a scan signal on the scan line (GL) cannot be reduced to a sufficient extent in using the common inversion driving is particularly problematic in using a liquid crystal mode that needs a high drive voltage. For example, a drive voltage for a liquid crystal material exhibiting a blue phase (hereinafter called blue phase liquid crystal) ranges from about +20 V to −20 V. In other words, the amplitude voltage of an image signal is about 40 V, and a voltage of 40 V or higher (e.g., 50 V) is needed as the amplitude voltage of a scan signal on the scan line (GL). Consequently, in a transistor to which a high voltage is applied e.g., a transistor used in a pixel, a high voltage is applied between a gate and a source or between a gate and a drain. This causes changes in the characteristics of a transistor, degradation of the characteristics of a transistor, or breakdown of a transistor.

In view of this, an object of one embodiment of the present invention is to provide a liquid crystal display device using the common inversion driving that allows the amplitude voltage of a scan signal on a scan line to be low.

One embodiment of the present invention is a liquid crystal display device including: a first transistor having a gate electrically connected to a scan line, a first terminal electrically connected to a signal line, and a second terminal electrically connected to a first electrode of a liquid crystal element; and a second transistor having a gate electrically connected to the scan line, a first terminal electrically connected to a common potential line, and a second terminal electrically connected to a second electrode of the liquid crystal element. An image signal is supplied from the signal line to the first electrode to subject the liquid crystal element to inversion driving. A common potential is supplied from the common potential line to the second electrode in synchronization with supply of the image signal.

One embodiment of the present invention may also be a liquid crystal display device in which the first electrode and the second electrode form a capacitor.

One embodiment of the present invention is a liquid crystal display device including: a first transistor having a gate electrically connected to a scan line, a first terminal electrically connected to a signal line, and a second terminal electrically connected to a first electrode of a liquid crystal element; and a second transistor having a gate electrically connected to the scan line, a first terminal electrically connected to a common potential line, and a second terminal electrically connected to a second electrode of the liquid crystal element. An image signal is supplied from the signal line to the first electrode to subject the liquid crystal element to inversion driving. The first electrode and a capacity line form a first capacitor. A common potential is supplied from the common potential line to the second electrode in synchronization with supply of the image signal. The second electrode and the capacity line form a second capacitor.

One embodiment of the present invention is a liquid crystal display device including: a first transistor having a gate electrically connected to a scan line, a first terminal electrically connected to a signal line, and a second terminal electrically connected to a first electrode of a liquid crystal element; and a second transistor having a gate electrically connected to the scan line, a first terminal electrically connected to a common potential line, and a second terminal electrically connected to a second electrode of the liquid crystal element. An image signal is supplied from the signal line to the first electrode to subject the liquid crystal element to inversion driving. The first electrode and the common potential line form a first capacitor. A common potential is supplied from the common potential line to the second electrode in synchronization with supply of the image signal. The second electrode and the common potential line form a second capacitor.

One embodiment of the present invention may also a liquid crystal display device in which the inversion driving is performed by applying an image signal that differs in polarity from one scan line to another to the liquid crystal element.

One embodiment of the present invention may also a liquid crystal display device in which the inversion driving is performed by applying an image signal that differs in polarity from one signal line to another to the liquid crystal element.

According to one embodiment of the present invention, it is possible to provide a liquid crystal display device that achieves low power consumption by reducing the amplitude voltage of a scan signal on a scan line in using the common inversion driving.

### BRIEF DESCRIPTION OF THE DRAWINGS

FIGS. 1A and 1B are a circuit diagram and a timing diagram according to one embodiment of the present invention.

FIGS. 2A and 2B are diagrams used to describe the potential of each signal according to one embodiment of the present invention.

FIG. 3 is a timing diagram according to one embodiment of the present invention.

FIGS. 4A and 4B are circuit diagrams according to one embodiment of the present invention.

FIG. 5 is a circuit diagram according to one embodiment of the present invention.

FIGS. 6A to 6C are block diagrams according to one embodiment of the present invention.

FIGS. 7A to 7C are a circuit diagram, a timing diagram, and a schematic diagram according to one embodiment of the present invention.

FIGS. 8A to 8C are a timing diagram, a schematic diagram, and a circuit diagram according to one embodiment of the present invention.

FIGS. 9A to 9C are a circuit diagram, a timing diagram, and a schematic diagram according to one embodiment of the present invention.

FIGS. 10A and 10B are a timing diagram and a schematic diagram according to one embodiment of the present invention.

FIGS. 11A to 11C are a circuit diagram, a timing diagram, and a schematic diagram according to one embodiment of the present invention.

FIGS. 12A and 12B are a plane view and a cross-sectional view according to one embodiment of the present invention.

FIGS. 13A to 13D are cross-sectional views according to one embodiment of the present invention.

FIGS. 14A to 14D are diagrams used to describe electronic appliances according to one embodiment of the present invention.

FIGS. 15A to 15C are a circuit diagram and timing diagrams used to describe inversion driving.

### DETAILED DESCRIPTION OF THE INVENTION

Embodiments of the present invention will be described below in detail with reference to the drawings. Note that the present invention can be implemented with various modes. It will be readily appreciated by those skilled in the art that modes and details of the present invention can be modified in various ways without departing from the spirit and scope of the present invention. Therefore, the present invention should not be construed as necessarily being as described in the embodiments below. Note that, in the structure of the present invention described below, identical objects in all the drawings are denoted by the same reference numeral.

Note that, the size, layer thickness, signal waveform, and region of each object shown in the drawings and the like of the embodiments are exaggerated for simplicity in some cases. Each object therefore is not necessarily in such scales.

Note that, in this specification, terms such as “first”, “second”, “third”, to “N (N is a natural number)” are used only for preventing confusion between components, and thus do not limit numbers.

### Embodiment 1

This embodiment will be described with a structure diagram of a pixel included in a liquid crystal display device and a timing diagram of each signal used to drive the liquid crystal display device.

Note that an example of the case where blue phase liquid crystal is used for a liquid crystal element according to Embodiment 1 will be described. Blue phase liquid crystal is driven by a horizontal electric field. The liquid crystal element is formed as follows: a common electrode, which is a second electrode of the liquid crystal element, is formed over the same substrate as a pixel electrode, which is a first electrode of the liquid crystal element. Note that the structure of this embodiment is not only used with blue phase liquid crystal, but also used with liquid crystal driven by horizontal electric field or liquid crystal allowing the first electrode and the second electrode to be formed over the same substrate.

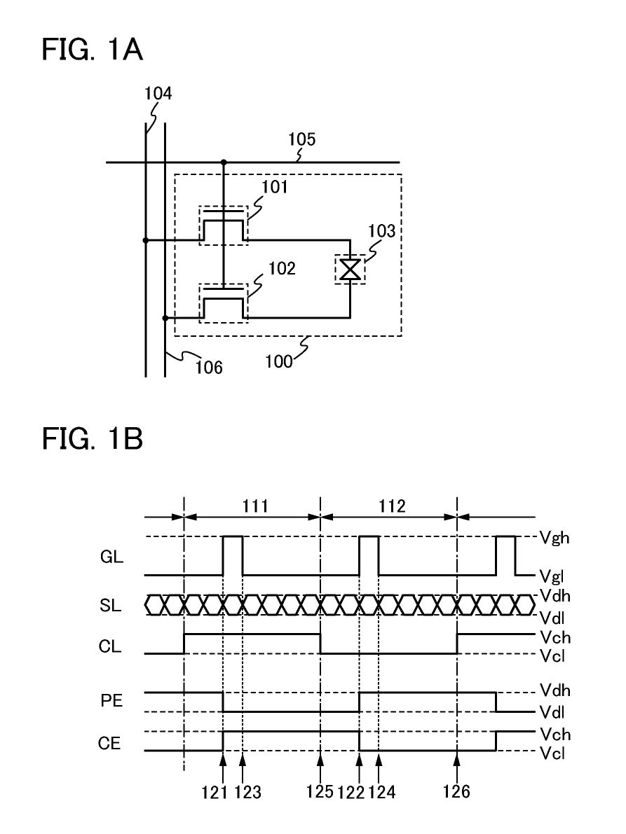

FIG. 1A is an example of a circuit diagram of a pixel. A pixel 100 includes a first transistor 101, a second transistor 102, and a liquid crystal element 103.

A first terminal of the first transistor 101 is connected to a signal line 104. A gate of the first transistor 101 is connected to a scan line 105. A second terminal of the first transistor 101 is connected to a first electrode (also referred to as a pixel electrode) of the liquid crystal element 103. A first terminal of the second transistor 102 is connected to a common potential line 106. A gate of the second transistor 102 is connected to a scan line 105. A second terminal of the second transistor 102 is connected to a second electrode (also referred to as a common electrode) of the liquid crystal element 103.

The gray level of each pixel for displaying an image is produced by changing the potentials of the first electrode and the second electrode of the liquid crystal element 103 and controlling the voltage applied to liquid crystal sandwiched between the first electrode and the second electrode of the liquid crystal element 103. The potential of the first electrode is controlled by controlling an image signal input to the signal line 104. The potential of the second electrode is controlled by controlling the potential of the common potential line 106. The potential of an image signal on the signal line 104 is supplied to the first electrode of the liquid crystal element 103 when the first transistor 101 is set in the conduction state. The potential of the common potential line 106 is supplied to the second electrode of the liquid crystal element 103 when the second transistor 102 is set in the conduction state.

Note that a pixel corresponds to a display unit controlling the luminance of one color component (e.g., any one of R (red), G (green), and B (blue)). Therefore, in a color display device, the minimum display unit of a color image is composed of three pixels of an R pixel, a G pixel and a B pixel. Note that the color of the color elements is not necessarily of three varieties and may be of three or more varieties or may include a color other than RGB.

Note that a transistor is an element having at least three terminals of gate, drain, and source. The transistor includes a channel region between a drain region and a source region, and current can flow through the drain region, the channel region, and the source region. Here, since the source and the drain of the transistor may change depending on the structure, the operating condition, and the like of the transistor, it is difficult to define which is a source or a drain. For this reason, in this specification, a region functioning as a source and a drain is not called the source or the drain in some cases. In such a case, for example, one of the source and the drain may be referred to as a first terminal and the other may be referred to as a second terminal. Alternatively, one of the source and the drain may be referred to as a first electrode and the other may be referred to as a second electrode. Alternatively, one of the source and the drain may be referred to as a source region and the other may be called a drain region.

Note that in this specification, the phrase “A and B are connected to each other” indicates the case where A and B are directly connected to each other, the case where A and B are electrically connected to each other, and the like. Here, the phrase “A and B are connected to each other” indicates, when an object having an electric function is placed between A and B, the case where a portion between A and B including the object is regarded as a node. Specifically, the phrase “A and B are connected to each other” indicates the case where a portion between A and B can be regarded as one node in consideration of circuit operation, for example, the case where A and B are connected through a switching element such as a transistor and have the same or substantially the same potential because of the conduction of the switching element, and the case where A and B are connected through a resistor and the potential difference generated at opposite ends of the resistor does not adversely affect the operation of a circuit including A and B.

Note that voltage refers to a potential difference between a given potential and a reference potential (e.g., a ground potential) in many cases. Therefore, voltage, potential and a potential difference can be referred to as potential, voltage, and a voltage difference, respectively.

A transistor in a pixel may be an inverted-staggered transistor or a staggered transistor. Alternatively, a transistor in a pixel may be a double-gate transistor may be used in which a channel region is divided into a plurality of regions and the divided channel regions are connected in series. Alternatively, a transistor in a pixel may be a dual-gate transistor may be used in which gate electrodes are provided over and under the channel region. Alternatively, a transistor in a pixel may be a transistor element having a semiconductor layer divided into a plurality of island-shaped semiconductor layers and achieving switching operation.

FIG. 1B is an example of a timing diagram used to describe the operation of the pixel 100 shown in FIG. 1A. In FIG. 1B, GL represents the potential of the scan line 105; SL, the amplitude voltage of an image signal on the signal line 104; CL, the potential of the common potential line; PE, the potential of the first electrode; CE, the potential of the second electrode. A period 111 is an inversion driving period during which the liquid crystal element 103 is subjected to the inversion driving. A period 112 is a non inversion driving period during which the liquid crystal element 103 is subjected to the non inversion driving. A combination of a period 111 and a period 112 corresponds to one frame period.

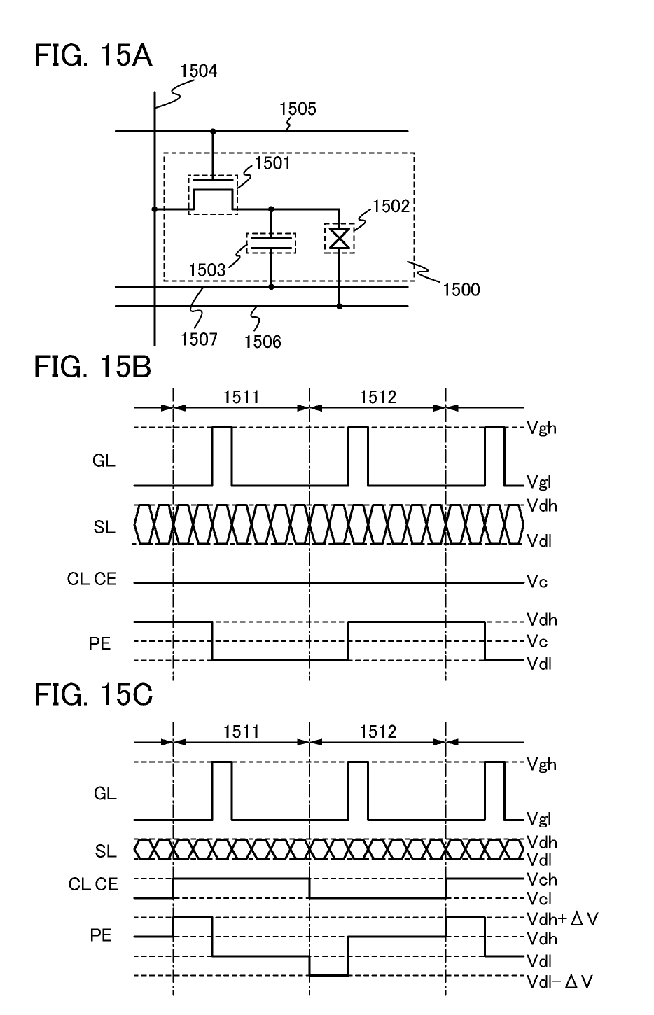

In FIG. 1B, the potential of the scan line 105 (GL) is Vgh in a period during which the pixel is selected, that is, a period during which the first transistor 101 and the second transistor 102 are set in the conduction state (turned on); and the potential of the scan line 105 (GL) is Vgl (Vgh>Vgl) in the other period, that is, a period during which the first transistor 101 and the second transistor 102 are set in the non-conduction state (turned off). The potential of the signal line 104 (SL) fluctuates according to a displayed image. Here, the potential used to perform the non inversion driving is Vdh, and the potential used to perform the inversion driving is Vdl (Vdh>Vdl). Note that FIG. 1B shows the case where the potential of the first electrode (PE) varies according to the gray level of an image signal on the signal line 104 (SL) and shows for convenience the scene where the potential is inverted between Vdh and Vdl according to a scan signal on the scan line (GL). In addition, in FIG. 1B, the amplitude voltage of an image signal is a value lower than the value Vch of the potential of the second electrode (CE), (Vdl) in the period 111; and the amplitude voltage of an image signal is a value higher than the value of the potential of the second electrode (CE) (Vdh) in a frame where the potential of the second electrode (CE) is at the low level (Vcl). Thus, as in the driving method that has been described with reference to FIG. 15C, the amplitude voltage of an image signal can be reduced to half Consequently, the amplitude voltage of the image signal can be made low, thereby reducing power consumption.

As shown in FIG. 1B, in the period 111 and the period 112, the potential of the scan line 105 (GL) is Vgh, and the first transistor 101 and the second transistor 102 are turned on at the time indicated by the arrow 121 and the arrow 122 shown in FIG. 1B, thereby selecting the pixel. In other words, an image signal is supplied from the signal line to the first electrode, and a common potential is supplied from the common potential line to the second electrode in synchronization with the supply of the image signal. Consequently, the potential of the first electrode (PE) is equal to the potential of an image signal at the time indicated by the arrow 121 in the period 111 shown in FIG. 1B. Further, the potential of the second electrode (CE) is equal to the potential of the common potential line (CL) at the time indicated by the arrow 122 in the period 112 shown in FIG. 1B. For example, if the potential of the common potential line (CL) is Vch when the pixel is selected in the period 111, the potential of an image signal is a potential lower than the potential Vch of the common potential line (CL) (Vdl). If the potential of the common potential line (CL) is Vcl when the pixel is selected in the period 112, the potential of an image signal is a potential higher than the potential Vcl of the common potential line (CL) (Vdh).

Then, as shown in FIG. 1B, in the period 111 and the period 112, the potential of the scan line 105 (GL) is Vgl, and the first transistor 101 and the second transistor 102 are turned off at the time indicated by an arrow 123 and an arrow 124 shown in FIG. 1B, thereby deselecting the pixel. Consequently, the values of the potential of the first electrode (PE) and the potential of the second electrode (CE) are the same as at the time when the pixel has been selected.

Next, as shown in FIG. 1B, when the potential of the scan line 105 (GL) is Vgl and the first transistor 101 and the second transistor 102 are off, the potential of the common potential line (CL) is inverted at the time indicated by an arrow 125 and an arrow 126 shown in FIG. 1B. The circuit configuration in FIG. 1A enables both the first transistor 101 and the second transistor 102 to be off. In other words, the first electrode (PE) and the second electrode (CE) between which the liquid crystal element 103 is sandwiched can be both electrically floating. Consequently, it is possible to prevent, when the pixel is deselected, variations in the potential of the first electrode (PE) due to capacitive coupling caused by reversing the potential of the common potential line (CL) from the low-level potential (Vcl) to the high-level potential (Vch), and the high-level potential (Vch) to the low-level potential (Vcl).

Thus, in the pixel shown in FIG. 1A, the potential of the first electrode (PE) remains unchanged even when the potential of the common potential line (CL) is inverted, so that, unlike in the driving method that has been described with reference to FIG. 15C, the amplitude voltage of a scan signal on the scan line (GL) can be made low.

Next, the potential of the scan line 1505 (GL), the potential of the common potential line 1506 (CL), the amplitude voltage of an image signal on the signal line 1504 (SL), which are shown in FIG. 15C, the potential of the scan line 105 (GL), the potential of the common potential line 106 (CL), and the amplitude voltage of an image signal on the signal line 104 (SL), which are shown in FIG. 1B, will be specifically described in terms of their potential levels. Further, an advantage of the common inversion driving according to one embodiment of the present invention such as low power consumption achieved by lowering the amplitude voltage of a scan signal on the scan line will be described.

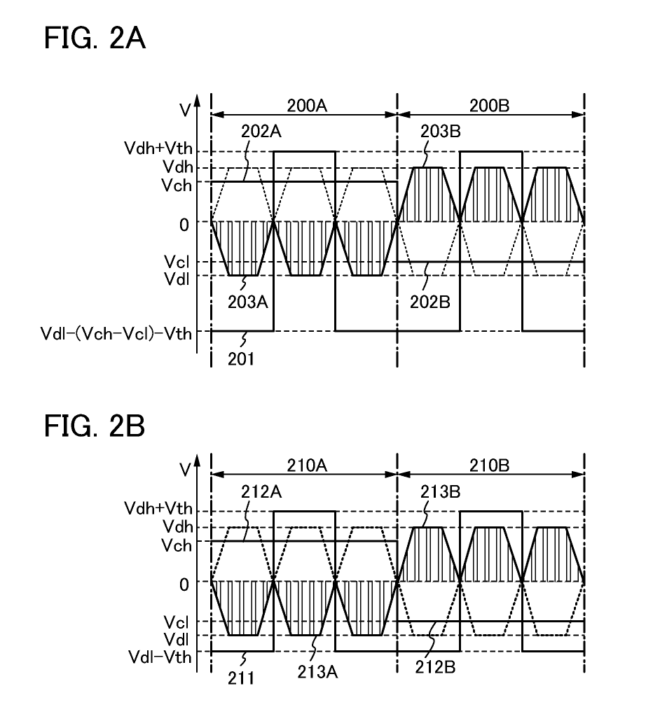

The diagram of FIG. 2A briefly shows the potential of the scan line 1505 (GL), the potential of the common potential line 1506 (CL), and the potential of the amplitude voltage of an image signal on the signal line 1504 (SL) that have been described with reference to FIG. 15C along with a period during which the liquid crystal element is subjected to the non inversion driving (the non inversion driving period) and a period during which the liquid crystal element is subjected to the inversion driving (an inversion driving period). The diagram of FIG. 2B briefly shows the potential of the scan line 105 (GL), the potential of the common potential line 106 (CL), and the potential of the amplitude voltage of an image signal on the signal line 104 (SL) that have been described with reference to FIG. 1B along with a period during which the liquid crystal element is subjected to the non inversion driving (a non inversion driving period) and a period during which the liquid crystal element is subjected to the inversion driving (an inversion driving period).

In FIG. 2A, the potential of the scan line 1505 (GL) is a signal 201; the potential of the common potential line 1506 (CL) in a period 200A which is a non inversion driving period is a signal 202A; the potential of the common potential line 1506 (CL) in a period 200B which is an inversion driving period is a signal 202B; the potential of the amplitude voltage of an image signal on the signal line 1504 (SL) in the period 200A which is a non inversion driving period is a signal 203A; the potential of the amplitude voltage of an image signal on the signal line 1504 (SL) in the period 200B which is an inversion driving period is a signal 203B. Note that in FIG. 2A, the threshold voltage of the transistor 1501 is Vth (Vth>0); the maximum value of the amplitude voltage of an image signal in the non inversion driving period is 0; the minimum value of the amplitude voltage of an image signal in the non inversion driving period is Vdl (Vdl<0); the maximum value of the amplitude voltage of an image signal in the inversion driving period is Vdh; the minimum value of the amplitude voltage of an image signal in the inversion driving period is 0; the potential of the common potential line 1506 (CL) at the high level in the non inversion driving period is Vch; the potential of the common potential line 1506 (CL) at the low level in the inversion driving period is Vcl (Vcl<0). Note that Vch is larger than 0 and smaller than Vdh, and Vcl is larger than Vdl and smaller than 0.

In the common inversion driving shown in FIG. 2A, the potential of the signal 201 at the high level (Vgh) is the maximum value of an image signal Vdh plus the threshold voltage of the transistor 1501 (Vth) (Vdh+Vth). The potential of the signal 201 at the low level (Vgl) is the minimum value of an image signal Vdl minus the threshold voltage of the transistor 1501 (Vth) and a difference between the potential of the common potential line 1506 (CL) at the high level (Vch) and the potential of the common potential line 1506 (CL) at the low level (Vcl), which is expressed by {Vdl−(Vch−Vcl)−Vth}. The potential of the signal 201 at the low level is set {Vdl−(Vch−Vcl)−Vth} in order to reduce the leakage of charge caused by the fact that when the potential of the common potential line 1506 (CL) is inverted, the potential of the first electrode (PE) serving as one of the electrodes between which the liquid crystal element is sandwiched is varied by capacitive coupling and becomes lower than the potential of the image signal.

In FIG. 2B, the potential of the scan line 105 (GL) is a signal 211; the potential of the common potential line 106 (CL) in a period 210A which is a non inversion driving period is a signal 212A; the potential of the common potential line 106 (CL) in a period 210B which is an inversion driving period is a signal 212B; the potential of the amplitude voltage of an image signal on the signal line 104 (SL) in the period 210A which is a non inversion driving period is a signal 213A; the potential of the amplitude voltage of an image signal on the signal line 104 (SL) in the period 210B which is an inversion driving period is a signal 213B. Note that in FIG. 2B, as in FIG. 2A, the threshold voltage of the first transistor 101 is Vth (Vth>0); the maximum value of the amplitude voltage of an image signal in the non inversion driving period is 0; the minimum value of the amplitude voltage of an image signal in the non inversion driving period is Vdl (Vdl<0); the maximum value of the amplitude voltage of an image signal in the inversion driving period is Vdh; the minimum value of the amplitude voltage of an image signal in the inversion driving period is 0; the potential of the common potential line 1506 (CL) at the high level in the non inversion driving period is Vch; the potential of the common potential line 1506 (CL) at the low level in the inversion driving period is Vcl (Vcl<0). Note that Vch is larger than 0 and smaller than Vdh, and Vcl is larger than Vdl and smaller than 0.

In the common inversion driving shown in FIG. 2B, the potential of the signal 211 at the high level (Vgh) is the maximum value of an image signal Vdh plus the threshold voltage (Vth) of the first transistor 101 (Vdh+Vth). The potential of the signal 211 at the low level (Vgl) is the minimum value of an image signal Vdl minus the threshold voltage (Vth) of the first transistor 101 (Vdl−Vth). In the circuit according to this embodiment described with reference to FIG. 2B, even if the potential of the signal 201 at the low level (Vgl) is (Vdl−Vth), the potential of the first electrode (PE) serving as one of the electrodes between which the liquid crystal element is sandwiched is not varied by capacitive coupling when the potential of the common potential line 106 (CL) is inverted, so that the potential of the signal 201 at the low level (Vgl) does not need to be lower than (Vdl−Vth). Consequently, in the circuit according to this embodiment described with reference to FIG. 2B, the amplitude voltage of a scan signal on the scan line 105 (GL) can be reduced, thereby achieving low power consumption.

As described above, the amplitude voltage of a scan signal on the scan line can be reduced. Consequently, a voltage applied to a transistor connected to the scan line can be reduced, preventing changes in the characteristics of a transistor, degradation of the characteristics of a transistor, breakdown of a transistor, or the like.

Embodiment 1 can be implemented in appropriate combination with the structures described in the other embodiments.

### Embodiment 2

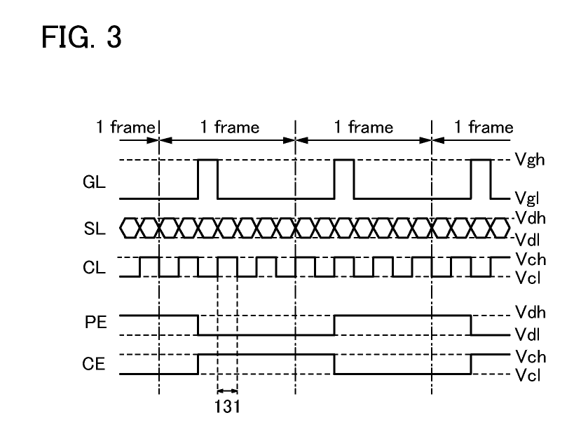

In this embodiment, a structure different from the structure that is used to drive the pixel shown in FIG. 1A and that has been described with reference to FIG. 1B in Embodiment 1 will be described with reference to the timing diagram of FIG. 3. The timing diagram of FIG. 3 is different from the timing diagram of FIG. 1B in showing the case where the potential of the common potential line (CL) is inverted between Vch and Vcl every gate selection period (which is a horizontal period and is shown as a period 131 in FIG. 3). Therefore, the potential of each wiring and the amplitude voltage of an image signal in FIG. 3 are the same as those in FIG. 1B. Note that the period 111 and the period 112 that have been described with reference to FIG. 1B correspond to one frame period and are denoted as 1 frame in FIG. 3.

In other words, as shown in FIG. 3, when the potential of the scan line 105 (GL) becomes Vgh and the first transistor 101 and the second transistor 102 are turned on in synchronization, the pixel is selected. In contrast, as shown in FIG. 3, when the potential of the scan line 105 (GL) becomes Vgl and the first transistor 101 and the second transistor 102 are turned off in synchronization, the pixel is deselected. Consequently, the potential of the first electrode (PE) and the potential of the second electrode (CE) are the same as at the time when the pixel has been selected. Consequently, as shown in FIG. 3, when the potential of the scan line 105 (GL) is Vgl and the first transistor 101 and the second transistor 102 are off, it is possible to prevent variations in the potential of the first electrode (PE) due to capacitive coupling caused by reversing the potential of the common potential line (CL) from the low-level potential (Vcl) to the high-level potential (Vch).

Note that the length of the period 131 may be inverted every two or more gate selection periods (e.g., every two or three gate selection periods). Thus, the power consumption of the liquid crystal display device can be reduced.

Thus, in the pixel shown in FIG. 1A, when the timing or period in the inversion driving in which the potential of the common potential line (CL) is inverted is changed, the potential of the first electrode (PE) can remain unchanged. Therefore, unlike the driving method that has been described with reference to FIG. 15C, the amplitude voltage of a scan signal on the scan line (GL) can be reduced.

Embodiment 2 can be implemented in appropriate combination with any of the structures described in the other embodiments.

### Embodiment 3

In Embodiment 3, the configuration of a pixel that is different from that of the pixel shown in FIG. 1A in Embodiment 1 will be described. Specifically, the configuration of a pixel including, in addition to the components in FIG. 1A, a first capacitor for holding the potential of the first electrode (PE) and a second capacitor for holding the potential of the second electrode (CE) will be described.

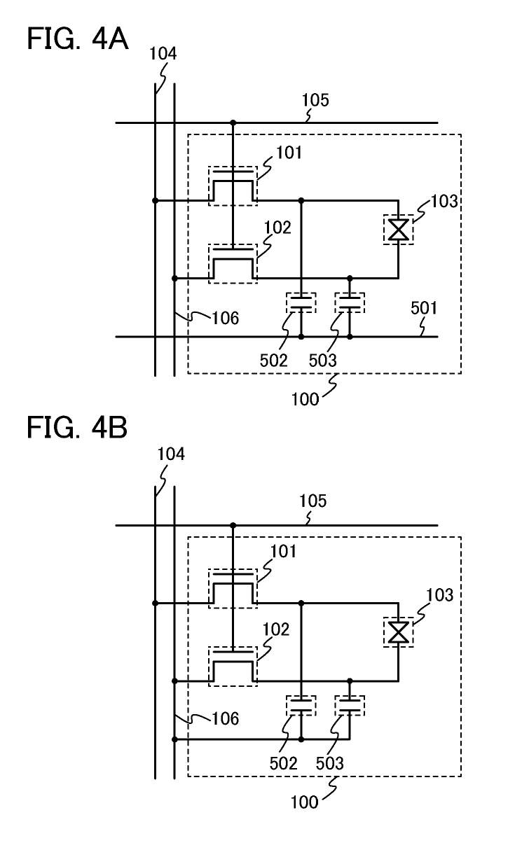

The pixel shown in FIG. 4A includes, in addition to the components in FIG. 1A, a capacity wiring 501; a first capacitor 502 including a capacity wiring 501 and a first electrode (PE) of a liquid crystal element 103; and a second capacitor 503 including a capacity wiring 501 and a second electrode (CE) of a liquid crystal element 103. Note that the first capacitor 502 or the second capacitor 503 can be omitted.

The pixel shown in FIG. 4B is the same as the pixel shown in FIG. 4A except that it does not include the capacity wiring 501 and it includes the first capacitor 502 including the first electrode (PE) and the common potential line 106, and the second capacitor 503 including the common potential line 106 and the second electrode (CE). The pixel shown in FIG. 4B allows the number of wirings to be reduced by the omission of the capacity wiring 501 compared to the pixel shown in FIG. 4A.

Note that alternatively, each of the first capacitor 502 and the second capacitor 503 can include the scan line 105 in another row (the previous row or the before the previous row) and the first electrode (PE) or the second electrode (CE).

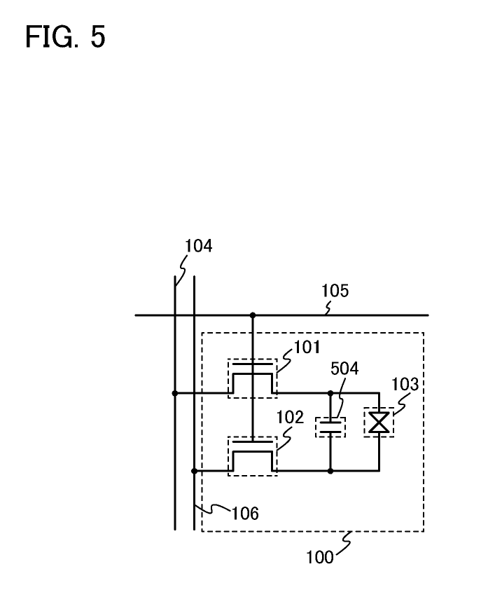

FIG. 5 shows a pixel including a capacitor 504 including the first electrode (PE) and second electrode (CE) of the liquid crystal element 103. The pixel shown in FIG. 4B allows the number of wirings to be reduced thanks to the capacity wiring 501 compared to the pixel shown in FIG. 4A.

Embodiment 3 can be implemented in appropriate combination with the structures described in the other embodiments.

### Embodiment 4

In this embodiment, the configuration of a display panel of a liquid crystal display device including the pixel according to Embodiment 1 shown in FIG. 1A will be described.

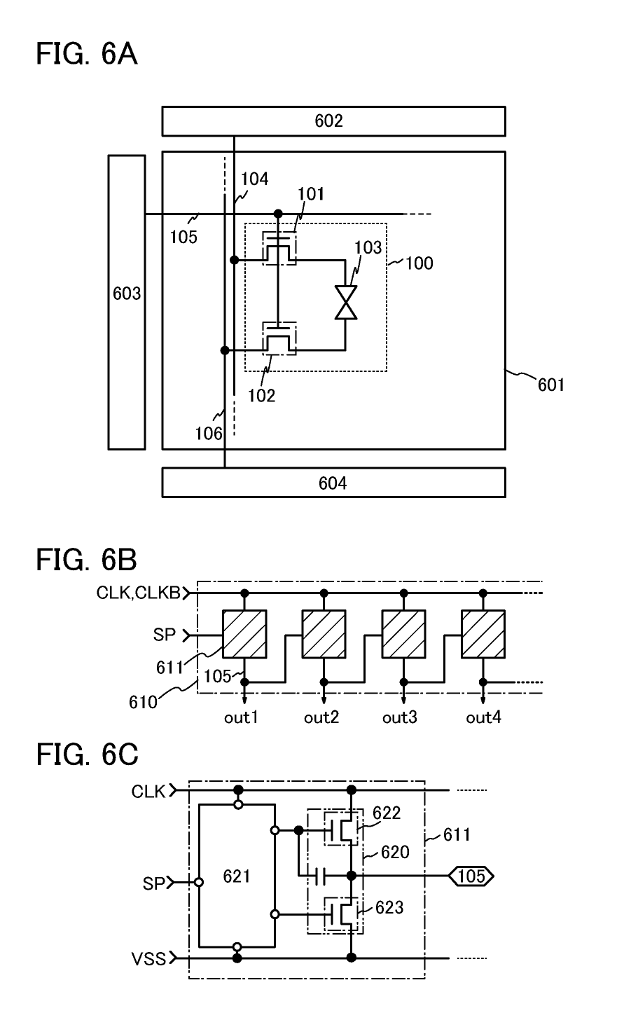

FIG. 6A is a schematic diagram of the display panel. The display panel shown in FIG. 6A includes a pixel area 601 having a plurality of pixels 100 each including the first transistor 101, the second transistor 102, and the liquid crystal element 103; a signal line driver circuit 602 used to drive the plurality of signal lines 104; a scan line driver circuit 603 used to drive the plurality of scan lines 105; and a common potential line driver circuit 604 used to drive the plurality of common potential lines 106.

Note that the signal line driver circuit 602, the scan line driver circuit 603, and the common potential line driver circuit 604 are preferably formed over the same substrate as the pixel area 601, but they are not necessarily formed over the same substrate as the pixel area 601. By forming the signal line driver circuit 602, the scan line driver circuit 603, and the common potential line driver circuit 604 over the same substrate as the pixel area 601, the number of connection terminals connected to external units can be reduced and a reduction in the size of the liquid crystal display device can be achieved.

Note that the pixels 100 are arranged (aligned) in a matrix. Here, the description that states “pixels are arranged (aligned) in a matrix” is intended for the case where the pixels are arranged directly or zig-zag in the longitudinal direction or lateral direction, and the like.

FIG. 6B shows an example of the configuration of a shift register circuit formed in the scan line driver circuit 603 to drive the plurality of scan lines 105. The shift register circuit 610 shown in FIG. 6B supplies a scan signal to be applied to output terminals out1 to outN (N is a natural number) of a plurality of pulse output circuits 611 in accordance with, for example, timing signals such as the clock signal CLK, the inversion clock signal CLKB, and the start pulse SP. In other words, the shift register circuit 610 supplies a scan signal to be sequentially applied to the gates of the first transistor 101 and the second transistor 102 through the scan line 105.

In the case where transistors in the pulse output circuit 611 shown in FIG. 6B are formed over the same substrate as the first transistors 101 and the second transistors 102 included in the pixels 100 in the pixel area 601, the pulse output circuits 611 have transistors which are all of the same conductivity type (hereinafter referred to as transistors of the same conductivity type). FIG. 6C shows a rough configuration of the pulse output circuit 611 with transistors of the same conductivity type.

The pulse output circuit 611 with transistors of the same conductivity type shown in FIG. 6C is divided broadly into a buffer 620 and a control circuit 621 for controlling the buffer. The buffer 620 includes a pull-up transistor 622 and a pull-down transistor 623 which are of the same conductivity type. The pull-up transistor 622 conducts bootstrap operation in accordance with the control of the control circuit 621, and is capable of supplying a signal based on the potential of the clock signal CLK at the high level to the scan line 105. For this reason, as the potential of a signal supplied to the scan line 105 becomes higher, the potential applied to a gate of the pull-up transistor 622 is set higher by the bootstrap operation. The configuration according to Embodiment 1 can reduce the amplitude voltage of a scan signal on the scan line 105. Consequently, it can be seen that a high potential applied to the gate of the pull-up transistor 622 can be lowered, reducing degradation of the shift register circuit with transistors of the same conductivity type.

Embodiment 4 can be implemented in appropriate combination with the structures described in the other embodiments.

### Embodiment 5

In this embodiment, a plurality of the pixels each of which is shown in FIG. 1A in Embodiment 1 and which are subjected to the inversion driving will be described.

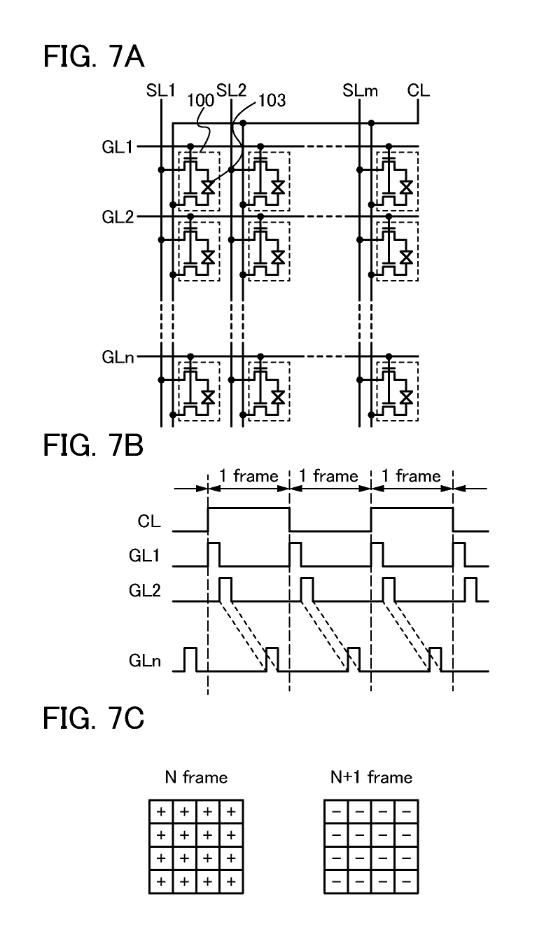

FIGS. 7A to 7C are a circuit diagram, a timing diagram, and a schematic diagram, which are obtained when the frame inversion driving is performed, respectively. FIG. 7A is a circuit diagram in which the pixels 100 are arranged in a matrix and all the pixels share one common potential line (CL). In FIG. 7A, a plurality of scan lines (GL) are shown as GL1 to GLn (n is any natural number), and a plurality of signal lines (SL) are shown as SL1 to SLm (m is any natural number).

FIG. 7B is a timing diagram used to describe the circuit diagram of FIG. 7A. In the frame inversion driving, the potential of the common potential line (CL) is inverted every frame. The period 111 and the period 112 that have been described with reference to FIG. 1B are denoted as 1 frame in FIG. 7B. Further, as described with reference to FIG. 1B, the potential of the common potential line (CL) is supplied to the second electrode (CE) in synchronization with the supply of an image signal from the signal line (SL) because of a scan signal from the scan line (GL).

The schematic diagram of FIG. 7C shows the scene where the polarity of a voltage applied between the first electrode (PE) and second electrode (CE) of the liquid crystal element 103 changes between positive and negative alternately (shown as + or − in the diagram) every frame during continuous frames: an N-th frame (N is any natural number) and a (N+1)-th frame. This is so-called the frame inversion driving.

Note that in the driving method that has been described with reference to FIG. 7B, the potential of the common potential line (CL) may be inverted every two or more frames (e.g., two or three frames). In this case, the polarity of a voltage applied between the first electrode (PE) and second electrode (CE) of the liquid crystal element 103 changes between positive and negative alternately every two or more frames. Thus, the power consumption of the liquid crystal display device can be reduced.

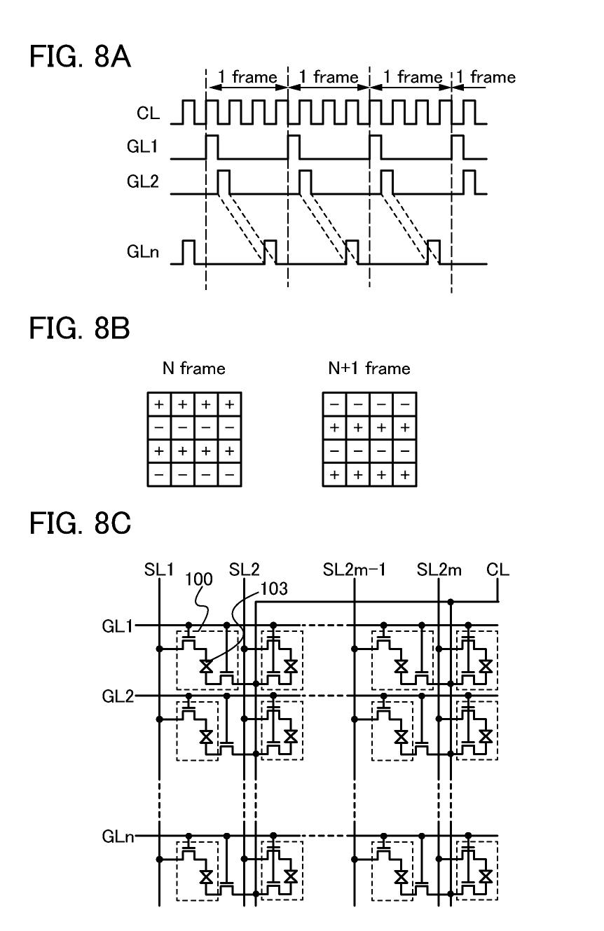

FIGS. 8A and 8B are a timing diagram and a schematic diagram, which are obtained when the gate line inversion driving is performed, respectively. Note that a circuit diagram related thereto is the same as that of FIG. 7A.

FIG. 8A is a timing diagram obtained when the circuit shown in FIG. 7A is driven by the gate line inversion driving. In the gate line inversion driving, the potential of the common potential line (CL) is inverted every gate selection period. The period 111 and the period 112 that have been described with reference to FIG. 1B are denoted as 1 frame in FIG. 8A. Further, as described with reference to FIG. 1B, the potential of the common potential line (CL) is supplied to the second electrode (CE) in synchronization with the supply of an image signal from the signal line SL1 because of a scan signal from the scan line GL1.

The schematic diagram of FIG. 8B shows the scene where the polarity of a voltage applied between the first electrode (PE) and second electrode (CE) of the liquid crystal element 103 changes between positive and negative alternately (shown as + or − in the diagram). FIG. 8B shows the scene where the polarity of a voltage applied between the first electrode (PE) and second electrode (CE) of the liquid crystal element 103 changes between positive and negative alternately on a row basis during continuous frames: an N-th frame (N is any natural number) and a (N+1)-th frame. This is so-called the gate line inversion driving.

Note that in the driving method that has been described with reference to FIG. 8A, the potential of the common potential line (CL) may be inverted every two or more gate selection periods (e.g., two or three gate selection periods). In this case, a positive voltage and a negative voltage are applied in turn to the liquid crystal elements 103 on two or more rows basis. Thus, the power consumption of the liquid crystal display device can be reduced.

In the circuit diagram of FIG. 7A, adjacent pixels share one common potential line (CL), thereby reducing the number of wirings. A specific configuration is shown in FIG. 8C. As shown in FIG. 8C, by using one line as a common potential line (CL) intended for the pixels placed in odd-numbered columns (one of which is SL2m−1 in FIG. 8C) and as a common potential line (CL) intended for the pixels placed in even-numbered columns (one of which is SL2m in FIG. 8C), an area for routing a common potential line (CL) to pixels in each column can be reduced.

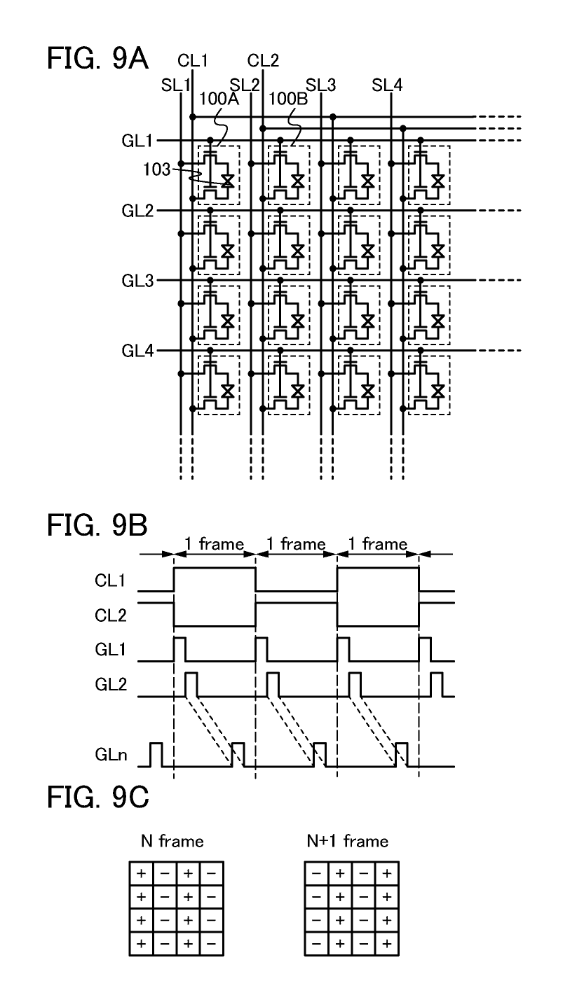

FIG. 9A to 9C are a circuit diagram, a timing diagram, and a schematic diagram, which are obtained when the source line inversion driving is performed, respectively. FIG. 9A is a circuit diagram in which pixels 100A which are placed in odd-numbered columns and pixels 100B which are placed in even-numbered columns are arranged in a matrix; the pixels 100A in odd-numbered columns share a first common potential line CL1; the pixels 100B in even-numbered columns share a second common potential line CL2. In FIG. 9A, a plurality of scan lines (GL) are shown as GL1 to GL4 (GLn (n is any natural number)), and a plurality of signal lines (SL) are shown as SL1 to SL4 (SLm (m is any natural number)).

Note that the first common potential line CL1 and the second common potential line CL2 can be shared by the pixels placed in a plurality of columns (e.g., two or three columns). For example, pixels placed in the first and second columns may be connected to the first common potential line CL1; pixels in the third and fourth columns may be connected to the second common potential line CL2; pixels in the fifth and sixth columns may be connected to the first common potential line CL1.

FIG. 9B is a timing diagram used to describe the circuit diagram of FIG. 9A. In the source line inversion driving, the potential of the first common potential line CL1 is inverted every frame; the potential of the second common potential line CL2 is inverted every frame; the potential of the first common potential line CL1 is in opposite phase to the potential of the second common potential line CL2. The period 111 and the period 112 that have been described with reference to FIG. 1B are denoted as 1 frame in FIG. 9B. As described with reference to FIG. 1B, in the pixels placed in odd-numbered columns, the potential of the first common potential line CL1 is supplied to the second electrode (CE) in synchronization with the supply of an image signal from the signal line SL1 because of a scan signal from the scan line GL1. In the pixels placed in even-numbered columns, the potential of the second common potential line CL2 is supplied to the second electrode (CE) in synchronization with the supply of an image signal from the signal line SL2 because of a scan signal from the scan line GL1.

The schematic diagram of FIG. 9C shows the scene where the polarity of a voltage applied between the first electrode (PE) and second electrode (CE) of the liquid crystal element 103 changes between positive and negative alternately (shown as + or − in the diagram) every frame during continuous frames: an N-th frame (N is any natural number) and a (N+1)-th frame. FIG. 9C shows the scene where the polarity of a voltage applied between the first electrode (PE) and second electrode (CE) of the liquid crystal element 103 changes between positive and negative alternately on a column basis during continuous frames: an N-th frame (N is any natural number) and a (N+1)-th frame. This is so-called the source line inversion driving.

Note that in the driving method that has been described with reference to FIG. 9C, the potential of the first common potential line CL1 and second common potential line CL2 may be inverted every two or more frames (e.g., two or three frames). In this case, the polarity of a voltage applied between the first electrode (PE) and second electrode (CE) of the liquid crystal element 103 changes between positive and negative alternately every two or more frames. Thus, the power consumption of the liquid crystal display device can be reduced.

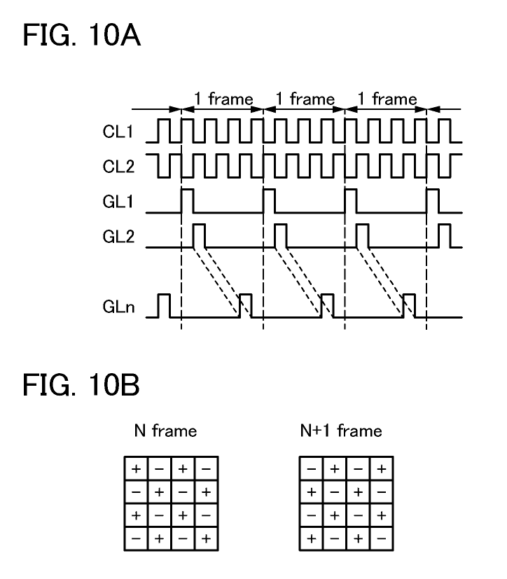

FIGS. 10A and 10B are a timing diagram and a schematic diagram, which are obtained when the dot inversion driving is performed, respectively. Note that a circuit diagram related thereto is the same as that of FIG. 9A.

FIG. 10A is a timing diagram obtained when the circuit shown in FIG. 9A is driven by the dot inversion driving. In the dot inversion driving, the potentials of the first common potential line CL1 connected to the pixels placed in odd-numbered columns and the second common potential line CL2 connected to the pixels placed in even-numbered columns are inverted every gate selection period. The period 111 and the period 112 that have been described with reference to FIG. 1B are denoted as 1 frame in FIG. 10A. As described with reference to FIG. 1B, in the pixels placed in odd-numbered columns, the potential of the first common potential line CL1 is supplied to the second electrode (CE) in synchronization with the supply of an image signal from the signal line SL1 because of a scan signal from the scan line GL1. In the pixels placed in even-numbered columns, the potential of the second common potential line CL2 is supplied to the second electrode (CE) in synchronization with the supply of an image signal from the signal line SL2 because of a scan signal from the scan line GL1.

The schematic diagram of FIG. 10B shows the scene where the polarity of a voltage applied between the first electrode (PE) and second electrode (CE) of the liquid crystal element 103 changes between positive and negative alternately (shown as + or − in the diagram) on a row basis and on a column basis. FIG. 10B shows the scene where the polarity of a voltage applied between the first electrode (PE) and second electrode (CE) of the liquid crystal element 103 changes between positive and negative alternately on a row basis and on a column basis during continuous frames: an N-th frame (N is any natural number) and a (N+1)-th frame. This is so-called dot inversion driving.

Note that in the driving method that has been described with reference to FIG. 10A, the potential of the common potential line (CL) may be inverted every two or more gate selection periods (e.g., two or three gate selection periods). In this case, a positive voltage and a negative voltage are applied in turn to the liquid crystal element 103 on one or more rows basis. Thus, the power consumption of the liquid crystal display device can be reduced.

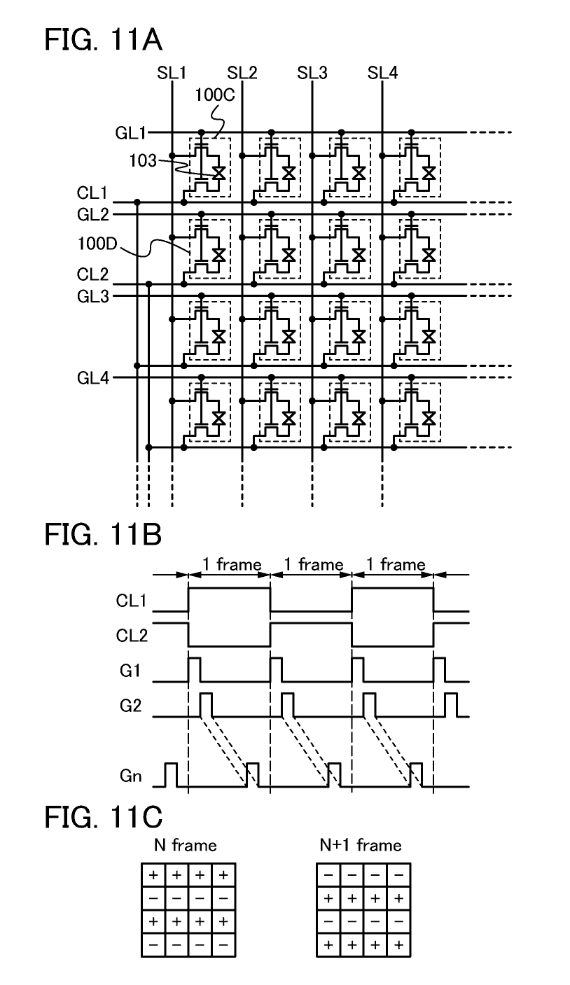

FIG. 11A to 11C are a circuit diagram, a timing diagram, and a schematic diagram, which are obtained when the gate line inversion driving different from the gate line inversion driving that has been described with reference to FIG. 7A, FIG. 8A, and FIG. 8B is performed, respectively. FIG. 11A is a circuit diagram in which pixels 100C which are placed in odd-numbered rows and pixels 100D which are placed in even-numbered rows are arranged in a matrix; the pixels 100C in odd-numbered rows share the first common potential line CL1; the pixels 100D in even-numbered rows share the second common potential line CL2. In FIG. 11A, a plurality of scan lines (GL) are shown as GL1 to GL4 (GLn (n is any natural number)), and a plurality of signal lines (SL) are shown as SL1 to SL4 (SLm (m is any natural number)).

Note that the first common potential line CL1 and the second common potential line CL2 can be shared by the pixels placed in a plurality of rows (e.g., two or three rows). For example, pixels placed in the first and second rows may be connected to the first common potential line CL1; pixels in the third and fourth rows may be connected to the second common potential line CL2; pixels in the fifth and sixth rows may be connected to the second common potential line CL2.

FIG. 11B is a timing diagram used to describe the circuit diagram of FIG. 11A. In the gate line inversion driving described with reference to FIG. 11A, the potential of the first common potential line CL1 is inverted every frame; the potential of the second common potential line CL2 is inverted every frame; the potential of the first common potential line CL1 is in opposite phase to the potential of the second common potential line CL2. The period 111 and the period 112 that have been described with reference to FIG. 1B are denoted as 1 frame in FIG. 11B. As described with reference to FIG. 1B, in the pixels placed in odd-numbered rows, the potential of the first common potential line CL1 is supplied to the second electrode (CE) in synchronization with the supply of an image signal from the signal line SL1 because of a scan signal from the scan line GL1. In the pixels placed in even-numbered rows, the potential of the second common potential line CL2 is supplied to the second electrode (CE) in synchronization with the supply of an image signal from the signal line SL1 because of a scan signal from the scan line GL2.

The schematic diagram of FIG. 11C shows the scene where the polarity of a voltage applied between the first electrode (PE) and second electrode (CE) of the liquid crystal element 103 changes between positive and negative alternately (shown as + or − in the diagram) every frame during continuous frames: an N-th frame (N is any natural number) and a (N+1)-th frame. FIG. 11C shows the scene where the polarity of a voltage applied between the first electrode (PE) and second electrode (CE) of the liquid crystal element 103 changes between positive and negative alternately on a row basis during continuous frames: an N-th frame (N is any natural number) and a (N+1)-th frame. This is so-called gate line inversion driving.

Note that in the driving method that has been described with reference to FIG. 11C, the potential of the first common potential line CL1 and second common potential line CL2 may be inverted every two or more frames (e.g., two or three frames). In this case, the polarity of a voltage applied between the first electrode (PE) and second electrode (CE) of the liquid crystal element 103 changes between positive and negative alternately every two or more frames. Thus, the power consumption of the liquid crystal display device can be reduced.

Embodiment 5 can be implemented in appropriate combination with the structures described in the other embodiments.

### Embodiment 6

In Embodiment 6, an example of a plan view and a cross-sectional view of a pixel of a display panel included in a liquid crystal display device will be described with reference to drawings.

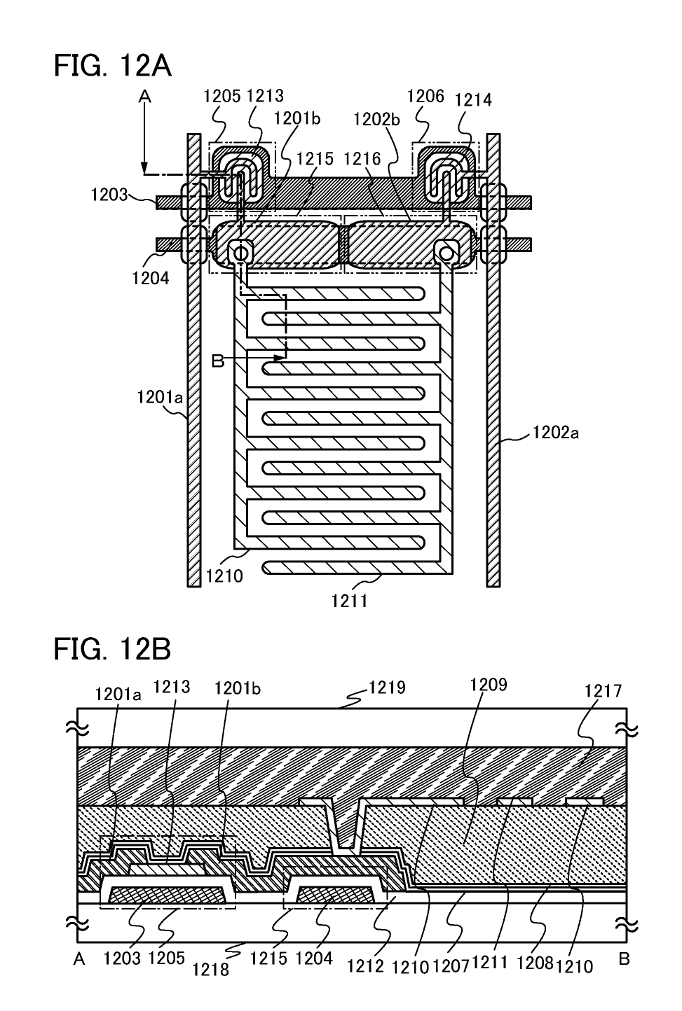

FIG. 12A is a plane view of one of a plurality of pixels included in the display panel. FIG. 12B is a cross-sectional view taken along the alternate long and short dashed line A-B shown in FIG. 12A.

In FIG. 12A, wiring layers (including a source electrode layer 1201a or a drain electrode layer 1201b) serving as signal lines are extended in the vertical direction (in the column direction) in the diagram. Wiring layers (including a source electrode layer 1202a or a drain electrode layer 1202b) serving as common potential lines are extended in the vertical direction (in the column direction) in the diagram. Wiring layers (including a gate electrode layer 1203) serving as scan lines are extended in the direction approximately orthogonal to the source electrode layer 1201a and the source electrode layer 1202a (in the horizontal direction (in the row direction) in the diagram). A capacity wiring layer 1204 is extended in the direction approximately parallel to the gate electrode layer 1203 and in the direction approximately orthogonal to the source electrode layer 1201a and the source electrode layer 1202a (in the horizontal direction (in the row direction) in the diagram).

In FIG. 12A, a first transistor 1205 and a second transistor 1206 which include a gate electrode layer 1203 are formed in a pixel of the display panel. An insulating film 1207, an insulating film 1208, and an interlayer film 1209 are formed over the first transistor 1205 and the second transistor 1206.

The pixel in the display panel shown in FIG. 12A and FIG. 12B includes a transparent electrode layer 1210 as a first electrode layer connected to the first transistor 1205; and a transparent electrode layer 1211 as a second electrode layer connected to the second transistor 1206. The transparent electrode layer 1210 and the transparent electrode layer 1211 are formed so that their comb-shapes may be in mesh and so that they may be separated. Openings (contact holes) are formed in the insulating film 1207, the insulating film 1208, and the interlayer film 1209 which are formed over the first transistor 1205 and the second transistor 1206. The transparent electrode layer 1210 is connected to the first transistor 1205 in the opening (contact hole), and the transparent electrode layer 1211 is connected to the second transistor 1206 in another opening (contact hole).

The first transistor 1205 shown in FIG. 12A and FIG. 12B includes a first semiconductor layer 1213 formed over the gate electrode layer 1203 through the gate insulating layer 1212; and a source electrode layer 1201a and a drain electrode layer 1201b which are in contact with the first semiconductor layer 1213. The second transistor 1206 shown in FIG. 12A includes a second semiconductor layer 1214 formed over the gate electrode layer 1203 through the gate insulating layer 1212; and a source electrode layer 1202a and a drain electrode layer 1202b which are in contact with the second semiconductor layer 1214. A stack of the capacity wiring layer 1204, the gate insulating layer 1212, and the drain electrode layer 1201b forms a first capacitor 1215. A stack of the capacity wiring layer 1204, the gate insulating layer 1212, and the drain electrode layer 1202b forms a second capacitor 1216.

Further, the first substrate 1218 overlaps with the second substrate 1219 with the first transistor 1205, the second transistor 1206, and the liquid crystal layer 1217 interposed therebetween.

Note that although an example of the case where a bottom-gate inverted staggered transistor is used as the first transistor 1205 has been described with reference to FIG. 12B, there is no particular limitation on the structure of a transistor applicable to the liquid crystal display device disclosed in this specification. For example, a top-gate transistor in which a gate electrode layer is placed on the upper side of a semiconductor layer with a gate insulating layer interposed therebetween; a bottom-gate staggered transistor or planar transistor in which a gate electrode layer is placed on the lower side of a semiconductor layer with a gate insulating layer interposed therebetween; or the like can be used.

Embodiment 6 can be implemented in appropriate combination with the structures described in the other embodiments.

### Embodiment 7

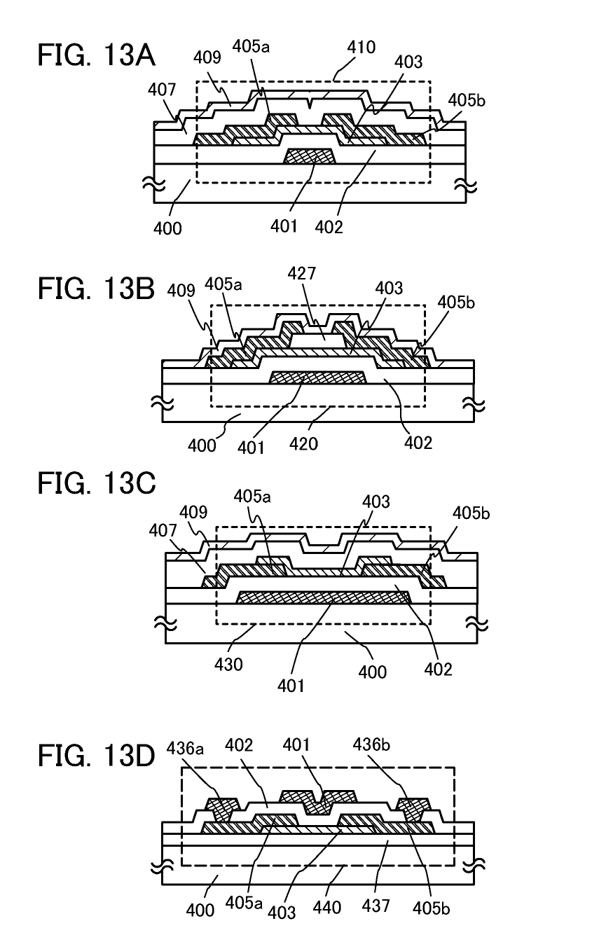

In Embodiment 7, an example of a transistor that can be applied to a liquid crystal display device disclosed in this specification will be described. There is no particular limitation on a structure of the transistor that can be applied to the liquid crystal display device disclosed in this specification. For example, a staggered transistor, a planar transistor, or the like having a top-gate structure in which a gate electrode is placed on the upper side of a semiconductor layer with a gate insulating layer interposed or a bottom-gate structure in which a gate electrode is placed on a lower side of a semiconductor layer with a gate insulating layer interposed, can be used. The transistor may have a single gate structure including one channel formation region, a double gate structure including two channel formation regions, or a triple gate structure including three channel formation regions. Alternatively, the transistor may have a dual gate structure including two gate electrode layers placed over and below a channel region with a gate insulating layer interposed. FIGS. 13A to 13D each show an example of the cross-sectional structure of a transistor.

Each of the transistors shown in FIGS. 13A to 13D uses an oxide semiconductor in its semiconductor layer. An advantage of using an oxide semiconductor is that a high field-effect mobility (the maximum value is 5 cm²/Vsec or more, preferably in the range of 10 cm²/Vsec to 150 cm²/Vsec) can be obtained when a transistor is on, and a low off-state current per unit channel width (e.g., less than 1 aA/μm, preferably less than 10 zA/μm and less than 100 zA/μm at 85° C. per unit channel width) can be obtained when the transistor is off.

A transistor 410 shown in FIG. 13A is a bottom-gate transistor and is also referred to as an inverted staggered transistor.

The transistor 410 includes, over a substrate 400 having an insulating surface, a gate electrode layer 401, a gate insulating layer 402, an oxide semiconductor layer 403, a source electrode layer 405a, and a drain electrode layer 405b. An insulating film 407 is formed to cover the transistor 410 and to be stacked over the oxide semiconductor layer 403. Further, a protective insulating layer 409 is formed over the insulating film 407.

A transistor 420 shown in FIG. 13B is a bottom-gate transistor referred to as a channel-protective type (also referred to as a channel-stop type) transistor and is also referred to as an inverted staggered transistor.

The transistor 420 includes, over the substrate 400 having an insulating surface, the gate electrode layer 401, the gate insulating layer 402, the oxide semiconductor layer 403, an insulating layer 427 functioning as a channel protective layer covering a channel formation region of the oxide semiconductor layer 403, the source electrode layer 405a, and the drain electrode layer 405b. Further, the protective insulating layer 409 is formed to cover the transistor 420.

A transistor 430 shown in FIG. 13C is a bottom-gate transistor and includes, over the substrate 400 having an insulating surface, the gate electrode layer 401, the gate insulating layer 402, the source electrode layer 405a, the drain electrode layer 405b, and the oxide semiconductor layer 403. The insulating film 407 is formed to cover the transistor 430 and to be in contact with the oxide semiconductor layer 403. Further, the protective insulating layer 409 is formed over the insulating film 407.

In the transistor 430, the gate insulating layer 402 is formed over and in contact with the substrate 400 and the gate electrode layer 401; the source electrode layer 405a and the drain electrode layer 405b are formed over and in contact with the gate insulating layer 402. The oxide semiconductor layer 403 is formed over the gate insulating layer 402, the source electrode layer 405a, and the drain electrode layer 405b.

A transistor 440 shown in FIG. 13D is a top-gate transistor. The transistor 440 includes, over the substrate 400 having an insulating surface, an insulating layer 437, the oxide semiconductor layer 403, the source electrode layer 405a, the drain electrode layer 405b, the gate insulating layer 402, and the gate electrode layer 401. A wiring layer 436a and a wiring layer 436b are formed in contact with and are connected to the source electrode layer 405a and the drain electrode layer 405b respectively.

In Embodiment 7, the oxide semiconductor layer 403 is used as a semiconductor layer as described above. Examples of an oxide semiconductor used for the oxide semiconductor layer 403 include: a four-component metal oxide such as an In—Sn—Ga—Zn—O-based oxide semiconductor; a three-component metal oxide such as an In—Ga—Zn—O-based oxide semiconductor, an In—Sn—Zn—O-based oxide semiconductor, an In—Al—Zn—O-based oxide semiconductor, a Sn—Ga—Zn—O-based oxide semiconductor, an Al—Ga—Zn—O-based oxide semiconductor, and a Sn—Al—Zn—O-based oxide semiconductor; a two-component metal oxide such as an In—Zn—O-based oxide semiconductor, a Sn—Zn—O-based oxide semiconductor, an Al—Zn—O-based oxide semiconductor, a Zn—Mg—O-based oxide semiconductor, a Sn—Mg—O-based oxide semiconductor, and an In—Mg—O-based oxide semiconductor; an In—O-based oxide semiconductor; a Sn—O-based oxide semiconductor; a Zn—O-based oxide semiconductor; and an In—Ga—O-based oxide semiconductor. In addition, SiO₂ may be contained in the above oxide semiconductor. Here, for example, an In—Ga—Zn—O-based oxide semiconductor means an oxide film containing indium (In), gallium (Ga), and zinc (Zn), and there is no particular limitation on the composition ratio thereof. The In—Ga—Zn—O-based oxide semiconductor may contain an element other than In, Ga, and Zn.

As the oxide semiconductor layer 403, a thin film expressed by a chemical formula of InMO₃(ZnO)ₘ (m>0) can be used. Here, M represents one or more metal elements selected from Zn, Ga, Al, Mn, and Co. For example, M can be Ga, Ga and Al, Ga and Mn, Ga and Co, or the like.

In the case where an In—Zn—O-based material is used as an oxide semiconductor, a target therefore has a composition ratio of In:Zn=50:1 to 1:2 in an atomic ratio (In₂O₃:ZnO=25:1 to 1:4 in a molar ratio), preferably, In:Zn=20:1 to 1:1 in an atomic ratio (In₂O₃:ZnO=10:1 to 1:2 in a molar ratio), more preferably, In:Zn=15:1 to 1.5:1 in an atomic ratio (In₂O₃:ZnO=15:2 to 3:4 in a molar ratio). For example, a target used for the formation of an In—Zn—O-based oxide semiconductor has an atomic ratio expressed by the equation Z>1.5X+Y where In:Zn:O=X:Y:Z.

In each of the transistors 410, 420, 430, and 440 using the oxide semiconductor layer 403, the value of current in a transistor in the off state (off-state current value) can be reduced. Therefore, a capacitor for holding an electric signal such as an image signal can be designed to be small in a pixel. This enables improvement in the aperture ratio of a pixel, thereby achieving low power consumption corresponding to the improvement.

Further, since the off-state current of the transistors 410, 420, 430, and 440 using the oxide semiconductor layer 403 can be reduced, in the pixel, a holding time of an electric signal such as an image signal can be made longer and the interval of a write period can be set longer. Therefore, the cycle of one frame period can be made longer, and the frequency of refresh operations performed in a still-image display period can be reduced, thereby further enhancing the effect of suppressing power consumption. In addition, since the transistors can be separately formed in a driver circuit area and a pixel area over one substrate, the number of the components of the liquid crystal display device can be reduced.

There is no limitation on a substrate that can be applied to the substrate 400 having an insulating surface. For example, a glass substrate such as a glass substrate made of barium borosilicate glass or aluminosilicate glass can be used.

In the bottom-gate transistors 410, 420, and 430, an insulating film serving as a base film may be formed between the substrate and the gate electrode layer. The base film has a function of preventing diffusion of an impurity element from the substrate, and can be a single layer or a stack of a silicon nitride film, a silicon oxide film, a silicon nitride oxide film, or a silicon oxynitride film.

The gate electrode layer 401 can be a single layer or stack of any of the following materials: metal materials such as molybdenum, titanium, chromium, tantalum, tungsten, aluminum, copper, neodymium, and scandium; and alloy materials containing any of these materials as their main component.

The gate insulating layer 402 can be a single layer or a stack of any of the following: a silicon oxide layer, a silicon nitride layer, a silicon oxynitride layer, a silicon nitride oxide layer, an aluminum oxide layer, an aluminum nitride layer, an aluminum oxynitride layer, an aluminum nitride oxide layer, and a hafnium oxide layer, and can be formed by plasma CVD, sputtering, or the like. For example, a 200-nm-thick gate insulating layer is formed in such a manner that a first gate insulating layer that is a silicon nitride layer (SiN_{y} (y>0)) having a thickness of 50 nm to 200 nm is formed by plasma CVD and then a second gate insulating layer that is a silicon oxide layer (SiOₓ (x>0)) having a thickness of 5 nm to 300 nm is stacked over the first gate insulating layer.

As a conductive film used for the source electrode layer 405a and the drain electrode layer 405b, for example, a metal film containing an element selected from Al, Cr, Cu, Ta, Ti, Mo, and W and a metal nitride film containing any of the above elements as its main component (a titanium nitride film, a molybdenum nitride film, a tungsten nitride film, or the like) can be used. A metal film having a high melting point such as Ti, Mo, W, or the like or a metal nitride film of any of these elements (a titanium nitride film, a molybdenum nitride film, and a tungsten nitride film) may be stacked on one or both of a lower side or an upper side of a metal film of Al, Cu, or the like.

The same material as that of the source electrode layer 405a and the drain electrode layer 405b can be also used for conductive films used as the wiring layer 436a and the wiring layer 436b which are connected to the source electrode layer 405a and the drain electrode layer 405b respectively.

The conductive film to be the source electrode layer 405a and the drain electrode layer 405b (including a wiring layer formed using the same layer as the source electrode layer 405a and the drain electrode layer 405b) may be formed using conductive metal oxide. As the conductive metal oxide, indium oxide (In₂O₃), tin oxide (SnO₂), zinc oxide (ZnO), an alloy of indium oxide and tin oxide (In₂O₃—SnO₂, referred to as ITO), an alloy of indium oxide and zinc oxide (In₂O₃—ZnO), and such a metal oxide material containing silicon oxide can be used.

As the insulating films 407 and 427 being formed over the oxide semiconductor layer and as the insulating layer 437 being formed below the oxide semiconductor layer, an inorganic insulating film such as a silicon oxide film, a silicon oxynitride film, an aluminum oxide film, or an aluminum oxynitride film can be typically used.

For the protective insulating layer 409 formed over the oxide semiconductor layer, an inorganic insulating film such as a silicon nitride film, an aluminum nitride film, a silicon nitride oxide film, or an aluminum nitride oxide film can be used.

Further, a planarization insulating film may be formed over the protective insulating layer 409 so that surface roughness due to the transistor is reduced. As the planarization insulating film, an organic material such as polyimide, an acrylic resin, and a benzocyclobutene-based resin can be used. In addition to the above organic materials, a low-dielectric constant material (a low-k material) or the like can be used. Note that the planarization insulating film may be formed by stacking a plurality of insulating films of any of these materials.

As described above, the off-state current of a transistor having a highly-purified oxide semiconductor layer formed according to Embodiment 7 can be made low. Consequently, in the pixel, a holding time of an electric signal such as an image signal can be made longer and the interval of a write period can be set longer. Therefore, the cycle of one frame period can be made longer, and the frequency of refresh operations performed in a still-image display period can be reduced, thereby further enhancing the effect of suppressing power consumption. A highly-purified oxide semiconductor layer is preferable in that it can be formed without a process such as laser irradiation and allows a transistor to be formed on a large-scale substrate.

Embodiment 6 can be implemented in appropriate combination with the structures described in the other embodiments.

### Embodiment 8

A liquid crystal display device disclosed in this specification can be applied to a variety of electronic devices (including a game machine). Examples of electronic appliances are a television set (also referred to as a television or a television receiver), a screen of a computer or the like, a camera such as a digital camera or a digital video camera, a digital photo frame, a cellular phone (also referred to as a cell phone or a mobile phone), a portable game console, a personal digital assistant, an audio reproducing device, a large-sized game machine such as a pachinko machine, and the like. Examples of an electronic device including the liquid crystal display device according to the above embodiments will be described.

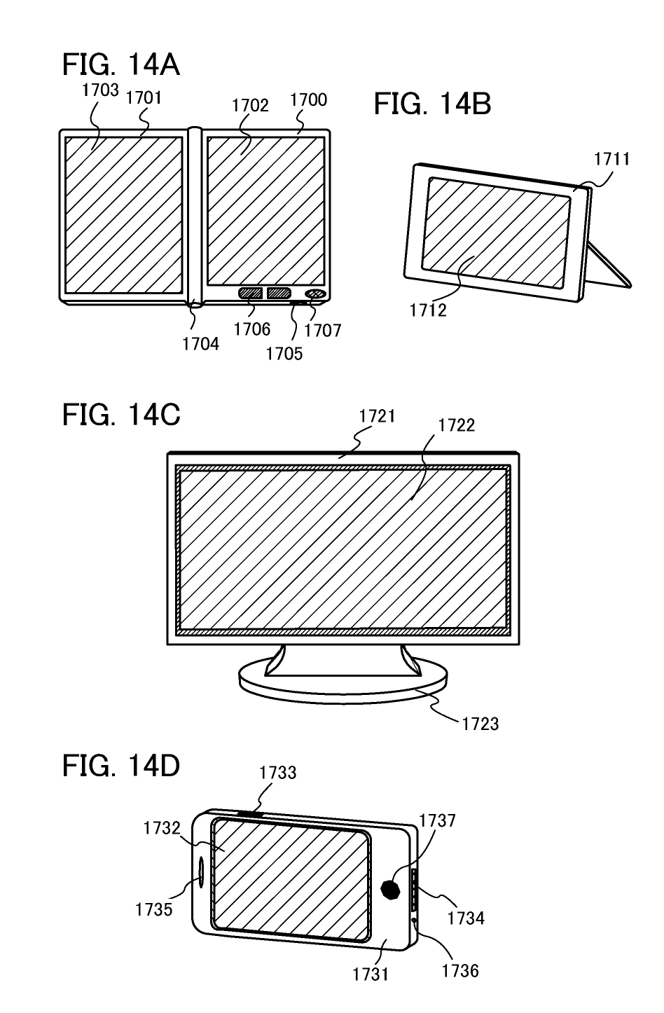

FIG. 14A shows an example of an electronic book device. The electronic book device shown in FIG. 14A includes two housings, a housing 1700 and a housing 1701. The housing 1700 and the housing 1701 are combined with a hinge 1704 so that the electronic book device can be opened and closed. Such a structure allows the electronic book device to operate like a paper book.

A display area 1702 and a display area 1703 are incorporated in the housing 1700 and the housing 1701, respectively. The display area 1702 and the display area 1703 may be configured to display one image or different images. In the case where the display area 1702 and the display area 1703 display different images, the display area on the right side (the display area 1702 in FIG. 14A) can display text and the display area on the left side (the display area 1703 in FIG. 14A) can display graphics, for example.

FIG. 14A shows an example of the case where the housing 1700 is provided with an operation portion and the like. For example, the housing 1700 is provided with a power input terminal 1705, operation keys 1706, a speaker 1707, and the like. It is possible to turn the pages with the operation keys 1706. Note that a keyboard, a pointing device, or the like may be provided on the surface of the housing, on which the display area is provided. Further, an external connection terminal (an earphone terminal, a USB terminal, a terminal that can be connected to various cables such as a USB cable, or the like), a recording medium insert portion, or the like may be provided on the back surface or the side surface of the housing. Further, the electronic book device shown in FIG. 14A may serve as an electronic dictionary.

FIG. 14B shows an example of a digital photo frame using a liquid crystal display device. For example, in the digital photo frame shown in FIG. 14B, a display area 1712 is incorporated in a housing 1711. The display area 1712 can display various images. For example, the display area 1712 can display data of an image taken with a digital camera or the like and thus function as a normal photo frame.

Note that the digital photo frame shown in FIG. 14B is provided with an operation portion, an external connection terminal (a USB terminal, a terminal that can be connected to various cables such as a USB cable, or the like), a recording medium insertion portion, and the like. Although these components may be provided on the surface on which the display area is provided, it is preferable to provide them on the side surface or the back surface for the design of the digital photo frame. For example, a memory storing data of an image taken with a digital camera is inserted in the recording medium insertion portion of the digital photo frame, so that the image data can be transferred and then displayed on the display area 1712.

FIG. 14C shows an example of a television set using a liquid crystal display device. In the television set shown in FIG. 14C, a display area 1722 is incorporated in a housing 1721. The display area 1722 can display an image. Further, the housing 1721 is supported by a stand 1723 here. The liquid crystal display device according to the above embodiments can be applied to the display area 1722.

The television set shown in FIG. 14C can be operated with an operation switch of the housing 1721 or a separate remote control device. Channels and volume can be controlled with an operation key of the remote control device so that an image displayed on the display area 1722 can be controlled. Further, the remote control device may be provided with a display area for displaying data output from the remote control device.

FIG. 14D shows an example of a cellular phone using a liquid crystal display device. The cellular phone shown in FIG. 14D is provided with a display area 1732 incorporated in a housing 1731, an operation button 1733, an operation button 1737, an external connection port 1734, a speaker 1735, a microphone 1736, and the like.

The display area 1732 of the cellular phone shown in FIG. 14D is a touchscreen. When the display area 1732 is touched with a finger or the like, contents displayed on the display area 1732 can be controlled. Further, operations such as making calls and texting can be performed by touching the display area 1732 with a finger or the like.

Embodiment 8 can be implemented in appropriate combination with the structures described in the other embodiments.

This application is based on Japanese Patent Application serial no. 2010-112269 filed with Japan Patent Office on May 14, 2010, the entire contents of which are hereby incorporated by reference.

What is claimed is:

1. A liquid crystal display device comprising:
a first transistor comprising a first gate, a first terminal, and a second terminal electrically connected to a scan line, a signal line, and a first electrode of a liquid crystal element, respectively; and
a second transistor comprising a second gate, a third terminal, and a fourth terminal electrically connected to the scan line, a common potential line, and a second electrode of the liquid crystal element, respectively,
wherein an image signal is supplied from the signal line to the first electrode to subject the liquid crystal element to inversion driving, and
wherein a common potential is supplied from the common potential line to the second electrode in synchronization with the image signal.

2. The liquid crystal display device according to claim 1, wherein the inversion driving is performed by applying the image signal that differs in polarity from one scan line to another scan line to the liquid crystal element.

3. The liquid crystal display device according to claim 1, wherein the inversion driving is performed by applying the image signal that differs in polarity from one signal line to another signal line to the liquid crystal element.

4. The liquid crystal display device according to claim 1, wherein at least one of the first transistor and the second transistor comprises an oxide semiconductor.

5. The liquid crystal display device according to claim 4, wherein the oxide semiconductor comprises at least one of indium, gallium, and zinc.

6. The liquid crystal display device according to claim 1, wherein the liquid crystal element comprises blue phase liquid crystal.

7. An electronic appliance comprising the liquid crystal display device according to claims 1.

8. A liquid crystal display device comprising:
a first transistor comprising a first gate, a first terminal, and a second terminal electrically connected to a scan line, a signal line, and a first electrode of a liquid crystal element, respectively; and
a second transistor comprising a second gate, a third terminal, and a fourth terminal electrically connected to the scan line, a common potential line, and a second electrode of the liquid crystal element, respectively,
wherein an image signal is supplied from the signal line to the first electrode to subject the liquid crystal element to inversion driving,
wherein the first electrode and the second electrode form a capacitor, and
wherein a common potential is supplied from the common potential line to the second electrode in synchronization with the image signal.

9. The liquid crystal display device according to claim 8, wherein the inversion driving is performed by applying the image signal that differs in polarity from one scan line to another scan line to the liquid crystal element.

10. The liquid crystal display device according to claim 8, wherein the inversion driving is performed by applying the image signal that differs in polarity from one signal line to another signal line to the liquid crystal element.

11. The liquid crystal display device according to claim 8, wherein at least one of the first transistor and the second transistor comprises an oxide semiconductor.

12. The liquid crystal display device according to claim 11, wherein the oxide semiconductor comprises at least one of indium, gallium, and zinc.

13. The liquid crystal display device according to claim 8, wherein the liquid crystal element comprises blue phase liquid crystal.

14. An electronic appliance comprising the liquid crystal display device according to claim 8.

15. A liquid crystal display device comprising:
a first transistor comprising a first gate, a first terminal, and a second terminal electrically connected to a scan line, a signal line, and a first electrode of a liquid crystal element, respectively; and
a second transistor comprising a second gate, a third terminal, and a fourth terminal electrically connected to the scan line, a common potential line, and a second electrode of the liquid crystal element, respectively,
wherein an image signal is supplied from the signal line to the first electrode to subject the liquid crystal element to inversion driving,
wherein the first electrode and a capacity line form a first capacitor,
wherein a common potential is supplied from the common potential line to the second electrode in synchronization with the image signal, and
wherein the second electrode and the capacity line form a second capacitor.

16. The liquid crystal display device according to claim 15, wherein the inversion driving is performed by applying the image signal that differs in polarity from one scan line to another scan line to the liquid crystal element.

17. The liquid crystal display device according to claim 15, wherein the inversion driving is performed by applying the image signal that differs in polarity from one signal line to another signal line to the liquid crystal element.

18. The liquid crystal display device according to claim 15, wherein at least one of the first transistor and the second transistor comprises an oxide semiconductor.

19. The liquid crystal display device according to claim 18, wherein the oxide semiconductor comprises at least one of indium, gallium, and zinc.

20. The liquid crystal display device according to claim 15, wherein the liquid crystal element comprises blue phase liquid crystal.

21. An electronic appliance comprising the liquid crystal display device according to claim 15.

22. A liquid crystal display device comprising:
a first transistor comprising a first gate, a first terminal, and a second terminal electrically connected to a scan line, a signal line, and a first electrode of a liquid crystal element, respectively; and
a second transistor comprising a second gate, a third terminal, and a fourth terminal electrically connected to the scan line, a common potential line, and a second electrode of the liquid crystal element, respectively,
wherein an image signal is supplied from the signal line to the first electrode to subject the liquid crystal element to inversion driving,
wherein the first electrode and the common potential line form a first capacitor,
wherein a common potential is supplied from the common potential line to the second electrode in synchronization with the image signal, and
wherein the second electrode and the common potential line form a second capacitor.

23. The liquid crystal display device according to claim 22, wherein the inversion driving is performed by applying the image signal that differs in polarity from one scan line to another scan line to the liquid crystal element.

24. The liquid crystal display device according to claim 22, wherein the inversion driving is performed by applying the image signal that differs in polarity from one signal line to another signal line to the liquid crystal element.

25. The liquid crystal display device according to claim 22, wherein at least one of the first transistor and the second transistor comprises an oxide semiconductor.

26. The liquid crystal display device according to claim 25, wherein the oxide semiconductor comprises at least one of indium, gallium, and zinc.

27. The liquid crystal display device according to claim 22, wherein the liquid crystal element comprises blue phase liquid crystal.

28. An electronic appliance comprising the liquid crystal display device according to claim 22.
